(19) United States
(12) Patent Application Publication
(10) Pub. No.: US 2015/0356478 A1
(43) Pub. Date: Dec. 10, 2015

(54) SYSTEM AND METHOD FOR RISK ASSESSMENT

(71) Applicant: The Texas A&M University System, College Station, TX (US)

(72) Inventors: Erich H. Fruchtnicht, Cypress, TX (US); Leslie D. Lutz, College Station, TX (US); John W. Fellers, Bryan, TX (US); Clay D. Hanks, College Station, TX (US)

(73) Assignee: THE TEXAS A&M UNIVERSITY SYSTEM, College Station, TX (US)

(21) Appl. No.: 14/730,693

(22) Filed: Jun. 4, 2015

Related U.S. Application Data
(60) Provisional application No. 62/007,480, filed on Jun. 4, 2014.

(51) Int. Cl. G06Q 10/06

(52) U.S. Cl. CPC G06Q 10/0635

(57) ABSTRACT

A system and method for assessing risk. In one embodiment, a system for risk assessment includes a processor and a storage device. The storage device is coupled to the processor, and stores instructions that when executed cause the processor to: 1) receive inspection result information for an inspected unit; 2) generate a probability of mishap value for the inspected unit based on the inspection result information; 3) generate a risk assessment code for the inspected unit based on the probability of mishap value; and 4) generate an inspection schedule for the inspected unit based on the risk assessment code.

### CROSS-REFERENCE TO RELATED APPLICATIONS

The present application claims priority to U.S. Provisional Patent Application No. 62/007,480, filed Jun. 4, 2014, entitled “System and Method for Risk Assessment,” which is hereby incorporated herein by reference in its entirety.

### BACKGROUND

Many organizations dedicate staff and resources to ensuring the safety of the organization's facilities. Regular and detailed inspections of the facilities may be performed to ensure safety. Using the data collected in the inspections, the organization can recommend facility improvements for code compliance, take proactive steps to address potential hazards, and create and assign training for personnel with access to the facilities to address any identified safety deficiencies. Because conducting safety inspections and performing risk assessment based on inspection results can be time consuming and labor intensive, techniques for reducing the time and cost associated with facility risk assessment are desirable.

### BRIEF DESCRIPTION OF THE DRAWINGS

For a detailed description of exemplary embodiments of the invention, reference will now be made to the accompanying drawings in which:

FIG. 1 shows a block diagram for a system for risk assessment in accordance with principles disclosed herein;

FIG. 2 shows a flow diagram for a method for risk assessment in accordance with principles disclosed herein; and

FIG. 3 shows a flow diagram for a method for risk assessment in accordance with principles disclosed herein.

### NOTATION AND NOMENCLATURE

In the following discussion and in the claims, the terms “including” and “comprising” are used in an open-ended fashion, and thus should be interpreted to mean “including, but not limited to . . . . ” In addition, the term “couple” or “couples” is intended to mean either an indirect or a direct connection. Thus, if a first device couples to a second device, that connection may be through a direct connection, or through an indirect connection accomplished via other devices and connections. Further, the term “software” includes any executable code capable of running on a processor, regardless of the media used to store the software. Thus, code stored in memory (e.g., non-volatile memory), and sometimes referred to as “embedded firmware,” is included within the definition of software. The recitation “based on” is intended to mean “based at least in part on.” Therefore, if X is based on Y, X may be based on Y and any number of other factors.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

A detailed facility safety inspection can require substantial time and effort when employing conventional methods of inspection and risk analysis. For example, a full inspection of a larger facility can require a multi-inspector team working 40 or more hours. Many more hours may be required to record and analyze the inspection results. As a result of the time and manpower required by conventional facility inspection and risk analysis, conventional methods may be economically expensive.

Embodiments of the present disclosure apply novel inspection and risk assessment methodologies that reduce the time and expense associated with assessing facility risk. Embodiments determine metrics for facility risk based on inspection data and establish a risk-based inspection schedule based on the determined risk metrics.

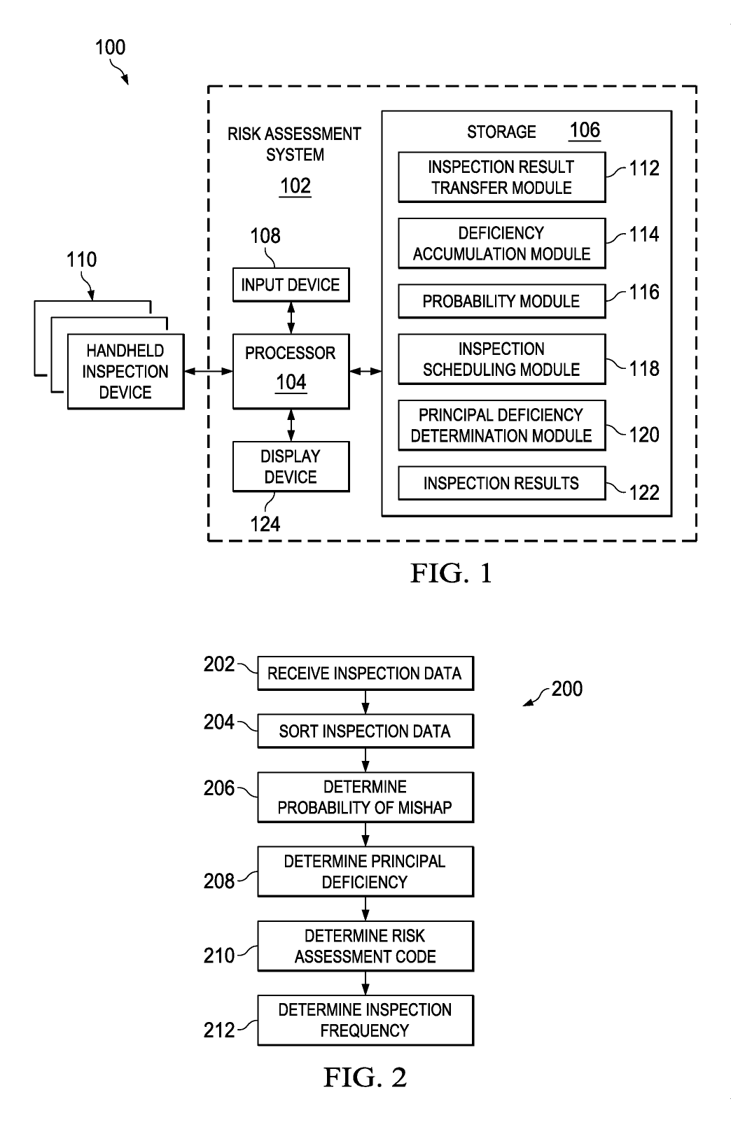

FIG. 1 shows a block diagram for a system 100 for inspecting a facility and assessing risk associated with the facility in accordance with principles disclosed herein. The system 100 includes one or more handheld inspection devices 110 and a risk assessment system 102. The handheld inspection device 110 may be a tablet computer or other portable computing device that includes instructions for presenting, to an inspector, information regarding the various rooms or other areas of the facility to be inspected, and information regarding various potential hazards that may be present in the areas of the facility to be inspected. The handheld inspection device 110 may also include instructions that provide for entry and storage of results of inspection of each inspected area or unit of the facility, and for transfer of the stored inspection results to the risk assessment system 102. The handheld inspection device 110 facilitates the inspection process by reducing inspection result information recording time and by improving the ease and accuracy of transfer of inspection result information to the risk assessment system 102.

The risk assessment system 102 receives and processes inspection result information transferred from the handheld inspection device 110 to determine what level of risk is presented by the facility and to establish a schedule for subsequent inspection of the facility. The risk assessment system 102 includes a processor 104, storage 106, a display device 124, and an input device 108. The risk assessment system 102 may also include miscellaneous interfaces that allow the risk assessment system 102 to communicate with other devices and systems. For example, the risk assessment system 102 may include one or more network interfaces that allow the risk assessment system 102 to communicate with another device via a wired or wireless network, such as a network compliant with IEEE 802.11, IEEE 802.3 or other wired or wireless networking standard.

The processor 104 is communicatively coupled to the storage 106, the display device 124, the input device 108, and other components and subsystems of the risk assessment system 102. The processor 104 may be a general-purpose microprocessor, a digital signal processor, a microcontroller, or other device capable of executing instructions retrieved from a computer-readable storage medium. Processor architectures generally include execution units (e.g., fixed point, floating point, integer, etc.), storage (e.g., registers, memory, etc.), instruction decoding, instruction and data fetching logic, peripherals (e.g., interrupt controllers, timers, direct memory access controllers, etc.), input/output systems (e.g., serial ports, parallel ports, etc.) and various other components and sub-systems.

The storage 106 is a non-transitory computer-readable storage medium suitable for storing instructions that are retrieved and executed by the processor 104 to perform the risk assessment functions disclosed herein. The storage 106 may include volatile storage such as random access memory, non-volatile storage (e.g., a hard drive, an optical storage device (e.g., CD or DVD), FLASH storage, read-only-memory), or combinations thereof. As understood by those skilled in the art, processors execute software instructions. Software instructions alone are incapable of performing a function. Therefore, in the present disclosure, any reference to a function performed by software instructions, or to software instructions performing a function is simply a shorthand means for stating that the function is performed by the processor 104 executing the instructions.

The display device 124 produces images rendered by the processor 104 for viewing by a user of the risk assessment system 102. The display device may be liquid crystal display (LCD), an organic light emitting diode (OLED) display, a plasma display, or any other type of display device suitable for producing images rendered by the processor 104.

The input device 108 is an instrument that can be manipulated by a user to control the risk assessment system 102. The input device 108 may be touch panel, such as a capacitive, resistive, or optical touch panel integrated with the display device 124 to form a touch screen. The input device 108 may also be a pointing device such as a mouse, a trackball, a touch pad, a camera-based input device, a keyboard, or any other instrument suitable for manipulation by a user to operate the risk assessment system 102.

The processor 104 executes instructions stored in and retrieved from the storage 106 to perform various functions of the risk assessment system 102. The instructions stored in the storage 106 include an inspection result transfer module 112, a deficiency accumulation module 114, a probability module 116, an inspection scheduling module 118, and a principal deficiency determination module 120. The inspection result transfer module 112 includes instructions that when executed by the processor 104 cause the processor 104 to transfer inspection result information from the one or more handheld inspection devices 110 to the risk assessment system 102 and to store the transferred inspection result information in the storage 106 as inspection results 122 for further processing. In some embodiments, the inspection result transfer module 112 may cause the processor 104 to transfer the inspection results from the handheld inspection device 110 via a wired or wireless network.

The deficiency accumulation module 114 includes instructions that when executed by the processor 104 cause the processor 104 to accumulate and sort the inspection results 122 for various areas and sub-areas inspected. For example, the inspection results 122 may be accumulated and sorted in accordance with the buildings, rooms of the buildings, and deficiency types for each room of an inspected facility.

The probability module 116 includes instructions that when executed by the processor 104 cause the processor 104 to determine the probability of a mishap occurring in the inspected unit based on the accumulated/sorted deficiency information for the inspected unit and known parameters of the inspected unit. In some embodiments, the probability of mishap may be determined to be a ratio of the total number of sub-areas of an inspected unit for which deficiencies were reported in the inspection results 212 to the total number of sub-areas of the inspected unit. In some embodiments, the probability module 116 may assign a probability level value to the determined probability of mishap where the probability level value is in accordance with a known safety standard. For example, the probability module 116 may assign a probability level value in accordance with MIL-STD-882 as shown in Table 1 below.

TABLE 1
MIL-STD-882 Probability Levels

| Category | | |
|---|---|---|
| Description | Level | Probability of Mishap |
| Frequent | A | Likely to occur frequently |
| Probable | B | Will occur several times during life cycle |
| Occasional | C | Likely to occur sometime |
| Remote | D | Unlikely, but may occur |
| Improbable | E | So unlikely that it can be assumed it will |
| | | not occur |

The probability module 116 may assign a probability level value based on the mishap probability ratio by assigning ranges to values of the ratio, where each range corresponds to a probability level. For example, considering Table 1 above, a mishap probability ratio value of 0.75 or greater may correspond to Level A, a mishap probability ratio value less than 0.75 and greater than or equal to 0.5 may correspond to Level B, a mishap probability ratio value less than 0.5 and greater than or equal to 0.25 may correspond to Level C, a mishap probability ratio value less than 0.25 and greater than or equal to 0.05 may correspond to Level D, and a mishap probability ratio value less than 0.05 may correspond to Level E. In some embodiments, different mishap probability ratio value ranges may correspond to the level values of Table 1, a different number of level values may be applied, level values of a different safety standard may be applied, etc.

The inspection scheduling module 118 includes instructions that when executed by the processor 104 cause the processor 104 to generate an inspection schedule for the inspected unit. Embodiments generate the inspection schedule based on the probability of mishap determined by the probability module 116 and a hazard classification associated with the inspected unit. A hazard classification for the inspected unit may be assigned based on the characteristics of the inspected unit. In some embodiments, a hazard classification is assigned in accordance with external hazard criteria, such as a hazard classification standard. For example, an assigned hazard classification may be based on the potential severity of an adverse event. Table 2 below shows exemplary hazard classification based on severity in accordance with MIL-STD-882.

TABLE 2
MIL-STD-882 Severity Categories

| Category | Category | |
|---|---|---|
| description | number | Possible resulting mishap |
| Catastrophic | I | Death or system loss |
| Critical | II | Severe injury or system damage |
| Marginal | III | Minor injury of system damage |
| Negligible | IV | Less than minor injury or system damage |

Embodiments may apply any hazard classification standard suitable for categorizing the inspected unit. For example, laboratory hazard classifications in accordance with National Fire Protection Association standards may be applied, biosafety levels in accordance with Center for Disease Control and Prevention standards may be applied, occupancy classifications in accordance with International Code Council standard may be applied, etc. Additional information regarding standards for hazard classification can be found in Erich Fruchtnicht et al., Safety Inspections Continuous Improvement, Effectiveness & Efficiency, Professional Safety (July 2013) which is incorporated herein by reference in its entirety.

The inspection scheduling module 118 may generate a risk assessment code by combining the probability of mishap and the hazard classification, and may select a frequency for subsequent inspection for the inspected unit based on the risk assessment code. The selected inspection frequency value may be presented to a user of the risk assessment system 102 to direct timing of future inspections of the inspected unit. Table 3 below shows generation of a risk assessment code by combining the probability level values of Table 1 with the severity categories of Table 2.

TABLE 3
Risk Assessment Codes

| | Hazard Categories | | | |
|---|---|---|---|---|
| Frequency of | Catastrophic | Critical | Marginal | Negligible |
| Occurrence | I | II | III | IV |
| A: Frequent | 1A | 2A | 3A | 4A |
| B: Probable | 1B | 2B | 3B | 4B |
| C: Occasional | 1C | 2C | 3C | 4C |
| D: Remote | 1D | 2D | 3D | 4D |
| E: Improbable | 1E | 2E | 3E | 4E |

Table 4 below shows exemplary assignment of inspection frequency based on the risk assessment code generated by combining mishap probability and hazard classification. An inspection frequency value may be assigned to each risk assessment code in accordance with the level of risk presented by the code. For example, in Table 4, lower risk assessment codes reflect higher risk that dictates more frequent inspection, while higher risk assessment codes reflect lower risk that results in less frequent inspection. Various embodiments may assign different inspection frequency values to the generated risk assessment codes as appropriate for the inspected unit. In some embodiments, the inspected unit may be assigned different inspection frequency values in accordance with different safety standards. For example, fire safety inspections may be assigned a first inspection frequency value based on a fire safety risk assessment code, and laboratory safety inspections may be assigned a second inspection frequency based on a laboratory safety risk assessment code.

TABLE 4
Inspection Frequency

| Risk Assessment Code | Inspection Frequency |
|---|---|
| 1A, 1B, 1C, 2A, 2B, 2C | Daily until corrected |
| 1D, 2C, 2D | Monthly |
| 3B, 3C | Quarterly |
| 1E, 2E, 3D, 3E, 4A-4E | Annual |

The principal deficiency determination module 120 includes instructions that when executed by the processor 104 cause the processor 104 to determine, based on the accumulated/sorted inspection results, what deficiency is reported as occurring most commonly (e.g., highest reported incidence) in the inspected unit. The identified principal deficiency may be reported to a user of the risk assessment system 102, in conjunction with the selected inspection frequency value, as a reason for the selected inspection frequency.

Some implementations of the risk assessment system 102 may be embodied in a computer as is known in the art. For example, the processor 104 and storage 106 may be provided by a desktop computer, a rack-mount computer, a server computer, or other computer suitable for storing and executing instructions that provide the risk assessment functionality described herein when executed.

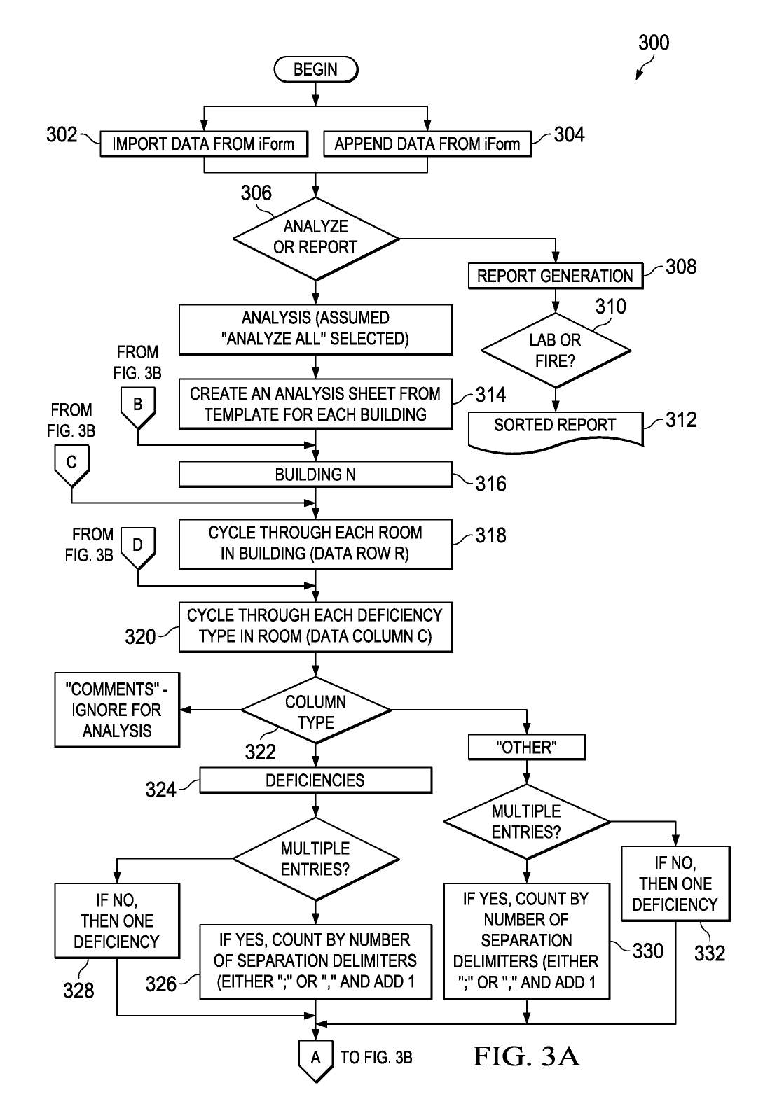

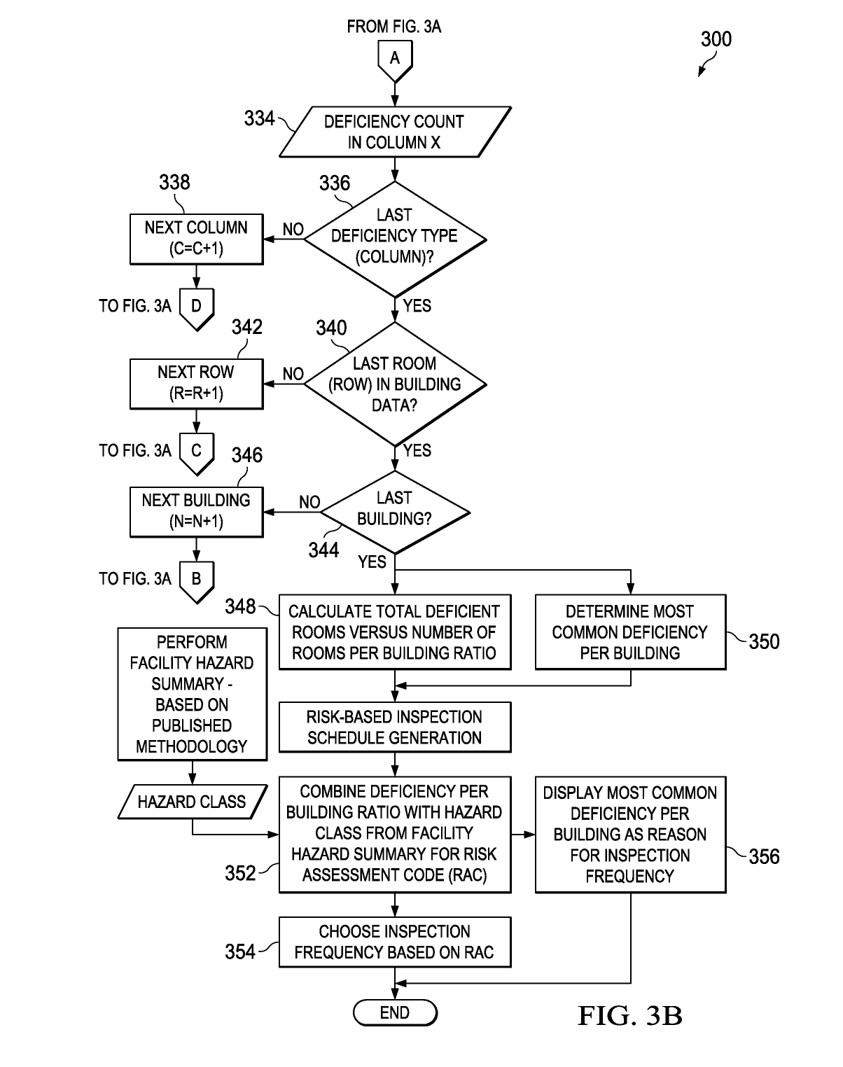

FIGS. 2 and 3 show flow diagrams for methods 200 and 300 for assessing risk based on inspection results in accordance with principles disclosed herein. Though depicted sequentially as a matter of convenience, at least some of the actions shown can be performed in a different order and/or performed in parallel. Additionally, some embodiments may perform only some of the actions shown. In some embodiments, at least some of the operations of the methods 200 and 300, as well as other operations described herein, can be implemented as instructions stored in the storage 106 and executed by the processor 104.

In block 202, the risk assessment system 102 receives the results of an inspection of an inspected unit from one or more handheld inspection device 110, and stores the received inspection result information in the storage 106 for further processing.

In block 204, the risk assessment system 102 sorts the inspection result information. The inspection results received from the one or more handheld inspection device 110 may be sorted and accumulated according to the area inspected, the inspected sub-areas of the area inspected, and/or deficiencies of the sub-areas identified during inspection.

In block 206, the risk assessment system 102 processes the sorted/accumulated inspection results to determine the probability of a mishap occurring in the inspected unit. The probability of mishap may be computed as a ratio of the total number of sub-areas of the inspected unit that have been found to exhibit a deficiency to the total number sub-areas of the inspected unit.

In block 208, the risk assessment system 102 determines the principal deficiency occurring in the inspected unit. The principal deficiency may be the deficiency that occurs the greatest number of times in the inspection results.

In block 210, the risk assessment system 102 produces a risk assessment code based on the determined probability of mishap a occurring and a hazard class associated with the area inspected.

In block 212, the risk assessment system 212 produces an inspection schedule that specifies an inspection frequency value to be applied to ongoing inspections of the inspected unit. The inspection frequency value is generated based on the risk assessment code. The risk assessment system may present the inspection frequency value to a user of the risk assessment system. The determined principal deficiency value may be presented to the user in conjunction with the inspection frequency value. The principal deficiency value may be presented as a reason for the selected inspection frequency.

The method 300 provides additional detail with regard to the operations disclosed in the method 200. In blocks 302-304, the inspection result information recorded while inspecting a facility (i.e., an inspected unit) is uploaded to the risk assessment system 102. Inspection result data received from a handheld inspection device 110 may be appended to inspection result information previously transferred to the risk assessment system 102 from a handheld inspection device 110.

In embodiments of the method 300, the inspection result information is organized in rows and columns such that each row of inspection information corresponds to a room or sub-area of an inspected building or unit, and each column represents a type of deficiency or other information relevant to the inspected room. In other embodiments, the inspection result information may be organized differently.

In block 306, the risk assessment system 102 determines whether a report is to be generated from the inspection result information, or a risk assessment is to be performed. If a report is be generated, then generation of a report is performed in block 308. The type of inspection result information to be included in the report is selected in block 310, and the report is completed in block 312.

If a risk assessment analysis is to be performed, then in block 314, the risk assessment system 102 generates an analysis structure for each inspected building, and risk analysis for a selected building commences in block 316.

The risk assessment system 102 processes each deficiency type of each room of the selected building in blocks 318-320. In blocks 322-334, the risk assessment system 102 determines the type of inspection result information presented in a column, and the number of deficiencies recorded for the type of inspection result. The total number of deficiencies recorded for the given building/room/column is determined in block 334.

In block 336, the risk assessment system 102 determines whether all deficiencies recorded for a room have been processed. If additional deficiency types are to be processed then a next column of the inspection results is selected in block 338 and deficiency processing for the room continues.

If all deficiency types for a room have been processed, then in block 340 the risk assessment system 102 determines whether all rooms of the current building have been processed. If additional rooms of the current building are to be processed, then in block 342 a next room of the building is selected for processing, and processing of the building continues.

If all rooms of a selected building have been processed, then in block 344 the risk assessment system 102 determines whether all buildings of the facility have been processed. If additional buildings of the facility are to be processed, then in block 346 a next building of the facility is selected for processing, and processing of the facility continues.

If all buildings of the facility have been processed, then in block 348 the risk assessment system 102 computes the probability of a mishap occurring as a ratio of the number rooms for which a deficiency was identified to the total number of rooms per building.

In block 350, the risk assessment system 102 evaluates the deficiencies recorded for each building and determines which deficiency is recorded most often for each building. The deficiency for which the most instances are recorded is identified as the principal deficiency for the building.

In block 352, the risk assessment system 102 combines a hazard class value for the facility with the computed probability of mishap to produce a risk assessment code. The hazard class value may be generated based on a known methodology applied to parameters of each building/room as disclosed herein.

In block 354, the risk assessment system 102 determines a frequency of inspection for the facility. The frequency of inspection is selected based on the risk assessment code generated for the facility.

In block 356, the risk assessment system 102 presents the selected frequency of inspection value and the principal deficiency for building to a user for use in planning of subsequent inspections.

Based on the principal deficiency identified by the risk assessment system 102, the probability of mishap determined by the risk assessment system 102, etc. provided to a user by the risk assessment system 102, changes may be made to an inspected facility to reduce the probability of mishap, to correct the principal deficiency or correct other deficiencies identified by the risk assessment system 102. Some embodiments of the risk assessment system 102 may recommend changes or improvements to be made in the facility to correct the identified deficiencies, set deadlines for completion of deficiency corrections, and reduce the overall risk presented by the inspected facility. For example, structural changes in the facility may be recommended to correct identified deficiencies.

The above discussion is meant to be illustrative of the principles and various embodiments of the present invention. Numerous variations and modifications will become apparent to those skilled in the art once the above disclosure is fully appreciated. For example, while some embodiments have been described herein with respect to facility inspection and risk assessment, those skilled in the art will understand that the principles disclosed herein are applicable to assessing risk associated with a wide variety of tangible inspection subjects or units. It is intended that the following claims be interpreted to embrace all such variations and modifications.

What is claimed is:

1. A system for risk assessment, comprising:
a processor;
a storage device coupled to the processor, the storage device comprising instructions that when executed cause the processor to:
receive inspection result information for an inspected unit;
generate a probability of mishap value for the inspected unit based on the inspection result information;
generate a risk assessment code for the inspected unit based on the probability of mishap value; and
generate an inspection schedule for the inspected unit based on the risk assessment code.

2. The system of claim 1, wherein the processor is configured to generate the probability of mishap based on a number of sub-areas of the inspected unit having safety deficiencies according to the inspection result information and a total number of inspected sub-areas of the inspected unit.

3. The system of claim 2, wherein the processor is configured to generate the probability of mishap as a ratio of the number of sub-areas of the inspected unit having safety deficiencies according to the inspection result information to the total number of inspected sub-areas of the inspected unit.

4. The system of claim 2, wherein the inspection result information comprises safety deficiency data for each of the plurality of sub-areas of the inspected unit.

5. The system of claim 1, wherein the processor is configured to generate, based on the risk assessment code, a value specifying frequency of inspection for the inspected unit.

6. The system of claim 5, wherein the processor is configured to determine a most frequently occurring safety deficiency for the inspected unit based on the inspection result information, and provide the determined most frequently occurring safety deficiency to be a reason for the value specifying frequency of inspection for the inspected unit.

7. The system of claim 1 wherein the processor is configured to generate the risk assessment code by combining the probability of mishap value with a hazard classification for the inspected unit; wherein the hazard classification is based on hazard characteristics of the inspected unit and external hazard criteria.

8. The system of claim 1, wherein the processor is configured to accumulate the inspection result information from inspection data recorded in a plurality of inspection reports for the inspected unit.

9. A method for assessing risk, comprising:
receiving, by a processor, inspection result information for an inspected unit;
generating, by the processor, a probability of mishap value for the inspected unit based on the inspection result information;
generating, by the processor, a risk assessment code for the inspected unit based on the probability of mishap value; and
generating, by the processor, an inspection schedule for the inspected unit based on the risk assessment code.

10. The method of claim 9, further comprising generating the probability of mishap based on a number of sub-areas of the inspected unit having safety deficiencies according to the inspection result information and a total number of inspected sub-areas of the inspected unit.

11. The method of claim 10, further comprising generating the probability of mishap as a ratio of the number of sub-areas of the inspected unit having safety deficiencies according to the inspection result information to the total number of inspected sub-areas of the inspected unit.

12. The method of claim 9, further comprising generating, based on the risk assessment code, a value specifying frequency of inspection for the inspected unit.

13. The method of claim 12 determining a most frequently occurring safety deficiency for the inspected unit based on the inspection result information, and providing the determined most frequently occurring safety deficiency to be a reason for the value specifying frequency inspection for the inspected unit.

14. The method of claim 9, further comprising generating the risk assessment code by combining the probability of mishap value with a hazard classification for the inspected unit; wherein the hazard classification is based on hazard characteristics of the inspected unit and external hazard criteria

15. The method of claim 9, wherein the inspection result information comprises safety deficiency data for each of a plurality of sub-areas of the inspected unit, and the receiving further comprises accumulating the inspection result information from inspection data recorded in a plurality of inspection reports for the inspected unit.

16. A non-transitory computer-readable medium encoded with instructions that when executed cause a processor to:
receive inspection result information for an inspected unit;
generate a probability of mishap value for the inspected unit based on the inspection result information;
generate a risk assessment code for the inspected unit based on the probability of mishap value; and
generate an inspection schedule for the inspected unit based on the risk assessment code.

17. The computer-readable medium of claim 16 encoded with instructions that when executed cause a processor to generate the probability of mishap as a ratio of a number of sub-areas of the inspected unit having safety deficiencies according to the inspection result information to a total number of inspected sub-areas of the inspected unit.

18. The computer-readable medium of claim 16 encoded with instructions that when executed cause a processor to generate, based on the risk assessment code, a value specifying frequency inspection for the inspected unit.

19. The computer-readable medium of claim 18 encoded with instructions that when executed cause a processor to determine a most frequently occurring safety deficiency for the inspected unit based on the inspection result information, and provide the determined most frequently occurring safety deficiency to be a reason for the value specifying frequency of inspection for the inspected unit.

20. The computer-readable medium of claim 16 encoded with instructions that when executed cause a processor to generate the risk assessment code by combining the probability of mishap value with a hazard classification for the inspected unit; wherein the hazard classification is based on hazard characteristics of the inspected unit and external hazard criteria.
